(19) United States
(12) Patent Application Publication
(10) Pub. No.: US 2023/0280812 A1
(43) Pub. Date: Sep. 7, 2023

(54) POWER MANAGEMENT DEVICE, POWER MANAGEMENT SYSTEM, POWER MANAGEMENT METHOD, AND POWER MANAGEMENT PROGRAM

(71) Applicant: Nippon Telegraph and Telephone Corporation, Tokyo (JP)

(72) Inventors: Koichi HARA, Musashino-shi, Tokyo (JP); Masashi KANEKO, Musashino-shi, Tokyo (JP)

(21) Appl. No.: 17/923,476

(22) PCT Filed: May 21, 2020
(86) PCT No.: PCT/JP2020/020168

§ 371 Date: Nov. 7, 2022

(51) Int. Cl. G06F 1/32

(52) U.S. Cl. CPC G06F 1/32

(57) ABSTRACT

A server has a power state including a power saving suspend state and an operating state in which power consumption is greater than in the suspend state. A proxy device, which maintains its operating state, includes a communication processing proxy portion that, upon receiving a request signal from a client for the server with the power state being the suspend state, reacts by itself as a proxy, and, upon receiving the request signal from the client for the server with the power state being the operating state, transfers the request signal to the server in the operating state, and a state controlling portion that, in response to the request signal, sends the server a returning signal for returning the power state of the server to the operating state, and, after the power state of the server transitions to the operating state, allows the server to perform the processing of the request signal read from the buffer.

### TECHNICAL FIELD

The present invention relates to a power management device, a power management system, a power management method, and a power management program.

### BACKGROUND ART

Computers such as servers comply with power management standards in order to control their power such as suspend state. As power management standards, the Advanced Power Management (APM), which controls power through the Basic Input/Output System (BIOS), and the Advanced Configuration and Power Interface (ACPI), which controls power from an operating system (OS), and the like have been widely used.

NPL 1 defines the power states from S0 (working state) to S5 (power off) as details of the ACPI standard. The larger the number after S, the higher the power saving effect, but the longer it takes to return.

In S1 (sleep mode), the central processing unit (CPU) is stopped, but the random access memory (RAM) remains energized. In S3 (suspend), most parts other than RAM are stopped. S5 (power off) is a state that consumes no power.

The Wake on LAN (WoL) function, which activates the power of a computer in response to an instruction from another computer, is also in widespread use for the purpose of computer remote control and the like. For example, WoL defines the procedure for transitioning from S3 (suspend) or S5 (power off) to S0 (working state).

Specifically, a WoL device that is always energized is implemented in advance on the computer to be awakened. Then, upon detecting the reception of an instruction packet (referred to as a magic packet) from another computer, the WoL device transitions the host computer to S0 (working state). NPL 2 describes a method for setting WoL.

### CITATION LIST

### Non Patent Literature

[NPL 1] UEFI Forum, Inc. “Advanced Configuration and Power Interface (ACPI) Specification Version 6.3”, [online], January 2019, [Searched May 7, 2020], Internet <URL: https://uefi.org/sites/default/files/resources/ACPI_6_3_final_ Jan30.pdf>
[NPL 2] Intel Corporation, “Remote Wake up Basics for Ethernet Products”, [online], Jan. 28, 2020, [Searched May 7, 2020], Internet <URL: https://www.intel.co.jp/content/www/jp/ja/support/articles/000 005793/network-and-io/ethernet-products.html>

### SUMMARY OF THE INVENTION

### Technical Problem

After receiving the magic packet, it requires some time before returning the computer to S0 (working state) with the WoL due to preparation such as the initialization process of the network interface. The OS cannot recognize any service request signal arriving from a client device during this preparation period, so that the request signal will be discarded.

Accordingly, to restart the processing of the request signal by the computer, it is necessary to wait for the lapse of the preparation period, resulting in a delay corresponding to the waiting time. For example, a request signal may be communication processing for enabling communication from the requesting client to the requested (returning) server.

If the aim is only to shorten the preparation period, the state may be maintained closer to S0 (working state), such as S1 (sleep mode). However, in S1 (sleep mode), many components in the computer remain energized before the arrival of a request signal, compromising the power saving effect.

As such, it is a main objective of the present invention to perform power management capable of responding to a request from another device with a short waiting time while maintaining a high power saving effect.

### Means for Solving the Problem

To achieve the objective, a power management device of the present invention has the following characteristics.

According to the present invention, a power management device configured to maintain an operating state regardless of a power state of a server, the power state including a power saving suspend state and an operating state in which power consumption is greater than in the suspend state, includes a processing proxy portion configured to
upon receiving a request signal from a client for the server with the power state being the suspend state, react by itself as a proxy, and
upon receiving the request signal from the client for the server with the power state being the operating state, transfer the request signal to the server in the operating state.

### Effects of the Invention

According to the present invention, it is possible to perform power management capable of responding to a request from another device with a short waiting time while maintaining a high power saving effect.

### BRIEF DESCRIPTION OF DRAWINGS

FIG. 1 is a configuration diagram of a communication system according to the present embodiment.

FIG. 2 is a configuration diagram showing a modification of the communication system of FIG. 1 according to the present embodiment.

FIG. 3 is a configuration diagram showing a modification of the communication system of FIG. 1 according to the present embodiment.

FIG. 4 is a transition diagram of the power state of a server according to the present embodiment.

FIG. 5 is a hardware configuration diagram of a server and a proxy device according to the present embodiment.

FIG. 6 is a flowchart showing a process performed when the server according to the present embodiment is in a suspend state.

FIG. 7 is a flowchart showing a process performed when the server according to the present embodiment is in a returning state.

FIG. 8 is a flowchart showing a process performed when the server according to the present embodiment is in an operating state.

FIG. 9 is a sequence diagram showing a Transmission Control Protocol (TCP) process of a comparison example.

FIG. 10 is a sequence diagram showing a TCP process according to the present embodiment.

FIG. 11 is a sequence diagram showing a User Datagram Protocol (UDP) process of a comparison example.

FIG. 12 is a sequence diagram showing a UDP process according to the present embodiment.

FIG. 13 is a sequence diagram showing a Stream Control Transmission Protocol (SCTP) process of a comparison example.

FIG. 14 is a sequence diagram showing an SCTP process according to the present embodiment.

### DESCRIPTION OF EMBODIMENTS

An embodiment of the present invention is described in detail below with reference to the accompanying drawings.

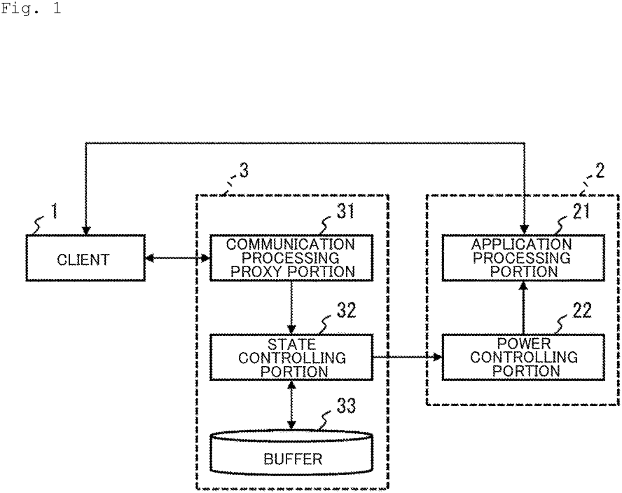

FIG. 1 is a configuration diagram of a communication system.

The communication system (power management system) includes a client 1, which requests services, a server 2, which provides services, and a proxy device (power management device) 3, which responds to a service request from the client 1 on behalf of the server 2. The server 2 transitions, where appropriate, to a suspend state to save power, while the proxy device 3 maintains its operating state (energized state) even when the server 2 is in the suspend state.

In the present embodiment, even though both the server 2 and the proxy device 3 are used, the power consumption is reduced as compared with when only the server 2 is used. This is because keeping the high-performance server 2 in the suspend state while operating the proxy device 3 of lower performance results in the sum of the power consumptions of the two devices being less than that in a situation where only the server 2 is constantly operated.

The server 2 has an application processing portion 21 and a power controlling portion 22.

The application processing portion 21 performs application processing for providing services. The power controlling portion 22 controls the power state of the server 2, such as transitioning from the suspend state to the operating state.

The proxy device 3 includes a communication processing proxy portion (processing proxy portion) 31, a state controlling portion 32, and a buffer 33.

The communication processing proxy portion 31 performs at least a part of the communication processing for providing a service, and thus the communication processing proxy portion 31 responds to a service request from the client 1 on behalf of the server 2 in the suspend state. The communication processing performed on behalf may be communication processing that uses only the IP address or the MAC address, such as connection processing with the client 1, for example.

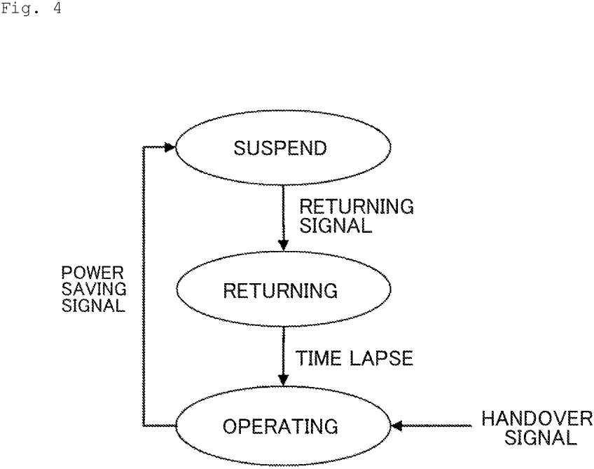

The state controlling portion 32 sends various signals to the power controlling portion 22 according to the content of the response of the communication processing proxy portion 31. Various signals may include a returning signal for transitioning the server 2 from the suspend state to the operating state (details are shown in FIG. 4). That is, the state controlling portion 32 causes the server 2 to return only when packet processing is required, allowing for a response with a short waiting time while maintaining a high power saving effect.

According to the response content of the communication processing proxy portion 31, the buffer 33 temporarily stores an application processing task (received packet) to be performed when the server 2 enters the operating state. That is, the task in the buffer 33 is handed over to the server 2 when the server 2 returns to the operating state. Accordingly, even during a period in which the server 2 is in the suspend state and cannot perform packet processing, packets are stored in the buffer 33, avoiding packet loss.

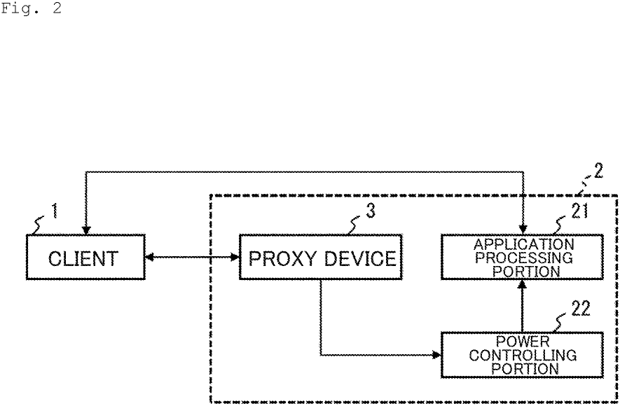

FIG. 2 is a configuration diagram showing a modification of the communication system of FIG. 1.

First, the proxy device 3 of FIG. 1 includes a CPU and a memory, and is configured as an external device connected to the server 2. In contrast, the proxy device 3 of FIG. 2 is built in the server 2 as a component that maintains its operating state even when the server 2 is in the suspend state. The component in the server may be a system on chip (SoC), a field-programmable gate array (FPGA) on a network interface card (NIC), or an application specific integrated circuit (ASIC).

The power control circuit implemented as a WOL device in the server 2 can also be used as the power controlling portion 22. Also, when the server 2 is in the operating state, the communication processing proxy portion 31 of the proxy device 3 transfers the request signal received from the client 1 to the application processing portion 21 via an internal bus, such as PCI Express.

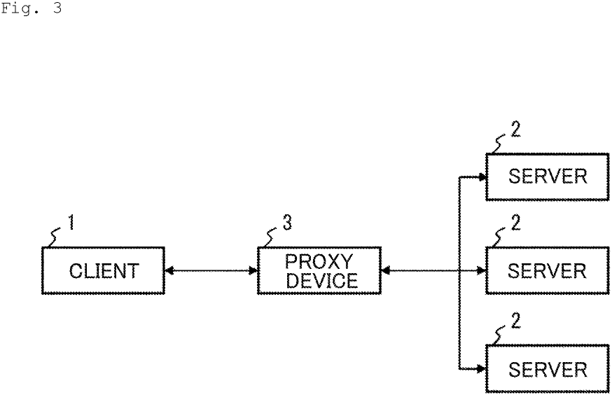

FIG. 3 is a configuration diagram showing a modification of the communication system of FIG. 1.

As in FIG. 1, the proxy device 3 in FIG. 3 is provided as an external device of the server 2. On the other hand, the proxy device 3 in FIG. 3 is connected to a plurality of servers 2. The communication processing proxy portion 31 of the proxy device 3 distributes the request signals received from the client 1 to servers 2 in the operating state. If no server 2 is in the operating state, a returning signal is transmitted to at least one server 2 to prompt a transition to the operating state.

FIG. 4 is a transition diagram of the power state of the server 2.

The power state of the server 2 is either a “suspend” state, which corresponds to S3 or S5 of the ACPI standard, a “returning” state, or an “operating” state, which corresponds to S0 of the ACPI standard. The power saving suspend state requires less power consumption than the operating state.

The state controlling portion 32 of the proxy device 3 sends a returning signal, a handover signal, and a power saving signal to the power controlling portion 22 of the server 2 to change the power state of the server 2.

First, the server 2 in the suspend state receives a returning signal and thus transitions to the returning state. For this purpose, the server 2 is provided with a WOL device, and the WOL device monitors a magic packet as a returning signal.

When the server 2 is in the suspend state or the returning state, the application processing portion 21 is not yet operating. As such, a task of the application processing portion 21 notified with a request signal from the client 1 is temporarily stored in the buffer 33 of the proxy device 3.

With a lapse of time, the server 2 in the returning state transitions to the operating state. The application processing portion 21 therefore operates, so that the tasks in the buffer 33 notified with a handover signal can be sequentially processed.

On the other hand, when the tasks in the buffer 33 are completed and a new request signal (task) is not generated for a while, the server 2 in the returning state receives a power saving signal and transitions to the suspend state. This provides a power saving effect.

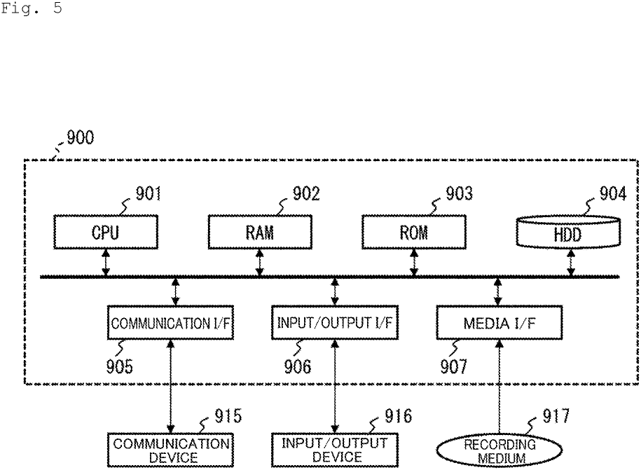

FIG. 5 is a hardware configuration diagram of the server 2 and the proxy device 3.

The server 2 and the proxy device 3 are each configured as a computer 900 including a CPU 901, a RAM 902, a ROM 903, an HDD 904, a communication I/F 905, an input/output I/F 906, and a media I/F 907.

The communication I/F 905 is connected to an external communication device 915. The input/output I/F 906 is connected to an input/output device 916. The media I/F 907 reads and writes data from and to a recording medium 917. The CPU 901 controls each processing portion by executing a program (also referred to as an application or an app for short) read into the RAM 902. The program can also be distributed via a communication line, or recorded and distributed on the recording medium 917 such as a CD-ROM.

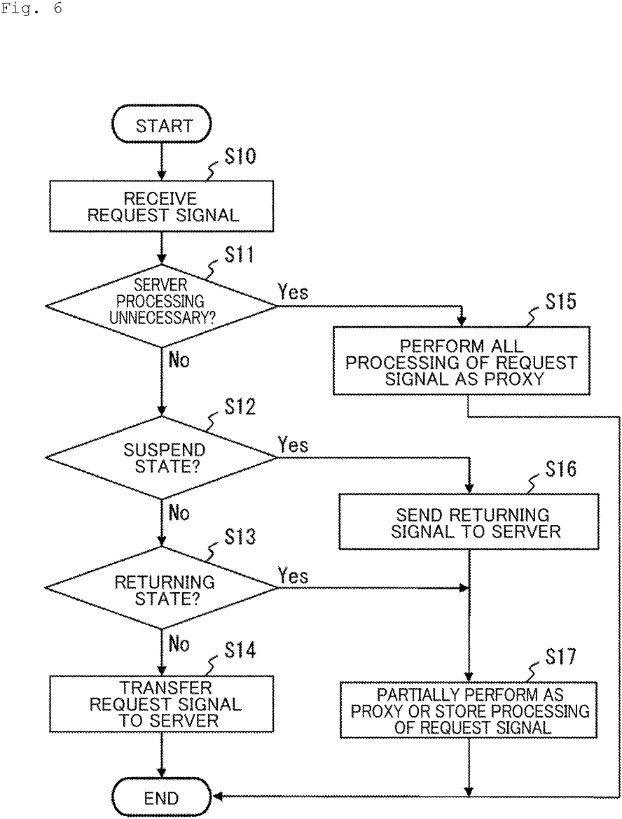

FIG. 6 is a flowchart showing a process performed when the server 2 is in the suspend state.

The communication processing proxy portion 31 receives a request signal from the client 1 (S10).

The communication processing proxy portion 31 checks the content of the received request signal and determines whether processing by the server 2 (the application processing portion 21) is unnecessary (S11). Request signals from the client 1 are classified into the following three classes. Class A is determined as Yes at S11, while Classes B and C are determined as No at S11.

(Class A: All delegated) A request signal that is completed only by processing by the communication processing proxy portion 31 and does not require processing by the application processing portion 21. For example, this request signal may be an echo request of ping in the ICMP, and the communication processing proxy portion 31 only needs to perform processing on the communication protocol, such as returning an echo response.

(Class B: Partially delegated) A request signal shared by processing by the communication processing proxy portion 31 and processing by the application processing portion 21. For example, this request signal may be a SYN (Synchronize) signal in the TCP, the communication processing proxy portion 31 returns an ACK + SYN (Acknowledge + Synchronize) signal, and the application processing portion 21 allocates a memory area for the connection to be established in response to the SYN signal.

(Class C: Cannot be delegated) The processing is not delegated to the communication processing proxy portion 31, and the request signal requires processing by the application processing portion 21. For example, this request signal may be a video signal transmission request, and the application processing portion 21 streams the requested video signal.

The communication processing proxy portion 31 processes the request signal of (Class A: All delegated) (S15). Thus, the request signal is immediately responded to without returning the server 2 in the suspend state, so that the response is given in a short time while maintaining the power saving effect.

The state controlling portion 32 determines whether the server 2 is in the suspend state (S12). If the answer is Yes at S12, the process proceeds to S16. If the answer is No, the process proceeds to S13. At S16, the state controlling portion 32 sends a returning signal to the power controlling portion 22 of the server 2 to prompt the server 2 to return (transition from suspend → returning → operating).

At S13, since the returning signal has already been sent, the state controlling portion 32 determines whether the server 2 is in the returning state (that is, whether it is in the operating state). If the answer is Yes at S13, the process proceeds to S17. If the answer is No, the process proceeds to S14.

At S17, since the application processing portion 21 cannot perform yet, the communication processing proxy portion 31 temporarily stores the request signal of (Class B: Partially delegated) or (Class C: Cannot be delegated) in the buffer 33. For (Class B: Partially delegated), the communication processing proxy portion 31 can perform in advance a part of the processing (communication processing) that can be delegated to the communication processing proxy portion 31.

At S14, since the server 2 is in the operating state, the communication processing proxy portion 31 transfers the request signal to be received thereafter to the application processing portion 21 of the server 2 to allow the application processing portion 21 to process.

Additionally, the communication processing proxy portion 31 sends a handover signal including request signals temporarily stored in the buffer 33 at S17 to the server 2 to allow the application processing portion 21 to retroactively process the request signals accumulated during the suspend or returning state.

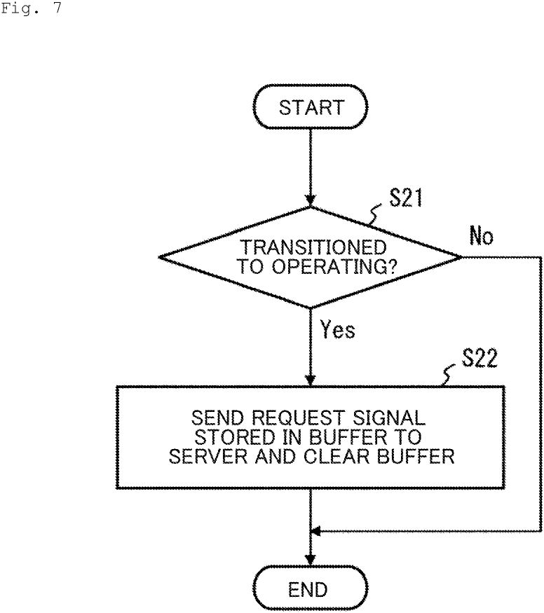

FIG. 7 is a flowchart showing a process performed when the server 2 is in the returning state.

The state controlling portion 32 determines whether the server 2 has transitioned to the operating state (S21). If the server 2 has transitioned to the operating state (Yes at S21), the communication processing proxy portion 31 sends the server 2 the request signal stored in the buffer 33 as a handover signal, and then clears the buffer 33 (S22).

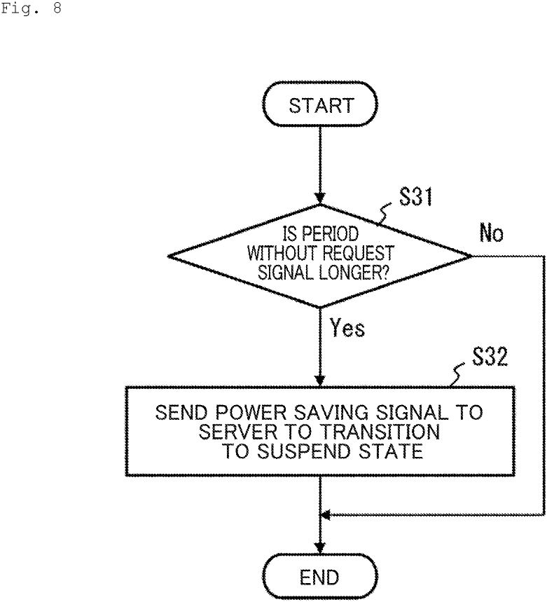

FIG. 8 is a flowchart showing a process performed when the server 2 is in the operating state.

The communication processing proxy portion 31 determines whether the period in which a request signal is not received is longer than a predetermined period (S31). If it is longer than the predetermined period (Yes at S31), the state controlling portion 32 sends a power saving signal to the server to transition the server 2 from the operating state to the suspend state (S32). This effectively sets an off-peak period in which a request signal is not received as a power saving period.

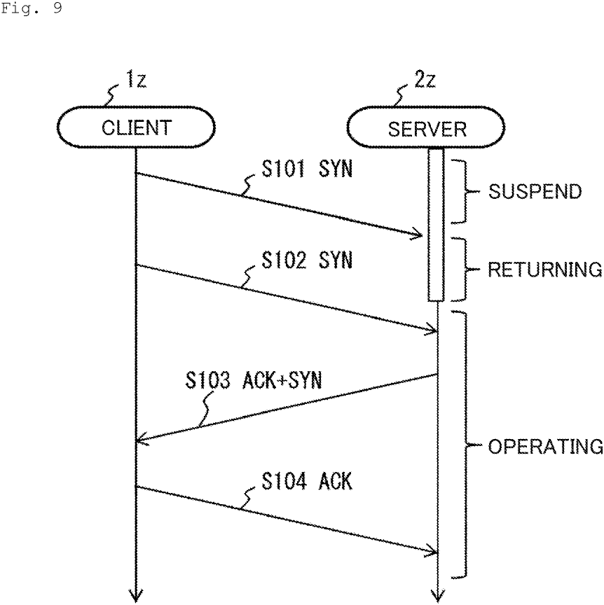

FIG. 9 is a sequence diagram showing a TCP process of a comparison example. In a communication system of the comparison example described below, a client 1z and a server 2z directly send and receive signals without using the proxy device 3 of the present embodiment.

The client 1z sends the first SYN signal to the server 2z (S101) . However, the SYN signal at S101 is not recognized by the server 2z because the server 2z is in the suspend state, causing packet loss. Then, the server 2z transitions from returning to operating when a magic packet is received or the power button is pressed, for example.

The client 1z sends (resends) the second SYN signal to the operating server 2z (S102). Since the SYN signal at S102 is correctly recognized by the operating server 2z, the reply of an ACK + SYN signal (S103) and the reception of an ACK signal (S104) successfully take place as the subsequent TCP 3-way handshake process.

As described above, in the comparison example of FIG. 9, the packet loss of the first SYN signal causes the client 1z to be forced to wait for the second SYN signal.

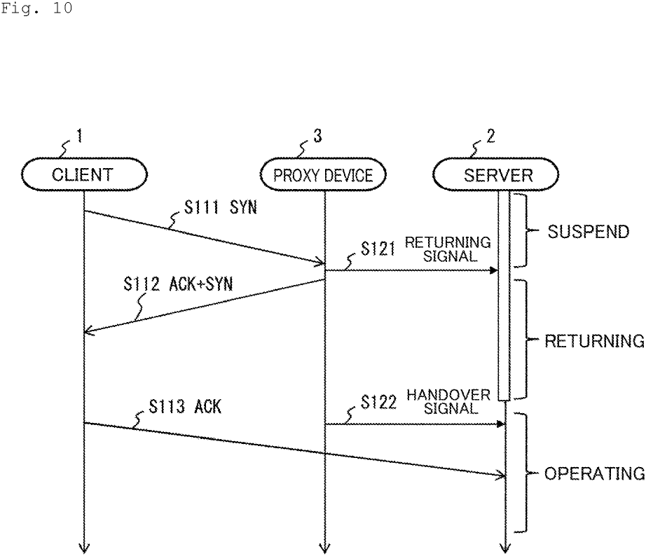

FIG. 10 is a sequence diagram showing a TCP process of the present embodiment.

The client 1 sends a SYN signal to the proxy device 3 (S111). The proxy device 3 returns an ACK + SYN signal to the client 1 on behalf of the server 2 in the suspend state (S112). The reply processing at S112 (Class B: Partially delegated) is immediately performed without waiting for the server 2 to return to the operating state.

The proxy device 3 stores the remaining processing belonging to the server 2 for the SYN signal at S111 in the buffer 33, and sends a returning signal to the server 2 (S121). This transitions the server 2 from returning to operating. Then, the proxy device 3 sends a handover signal to the server 2 that has transitioned to the operating state (S122) to allow the server 2 to perform the remaining processing belonging to the server 2 stored in the buffer 33.

Also, the client 1 sends an ACK signal, which is a response to S112, to the server 2 via the proxy device 3 (S113). Since the operating server 2 has already processed the tasks accumulated before operating (during the suspend or returning state) in response to the handover signal, the server 2 can immediately handle the ACK signal at S113.

As described above, in the TCP process of the present embodiment described with reference to FIG. 10, the proxy device 3 adjusts the power management between the client 1 and the server 2, so that the 3-way handshake process can be smoothly achieved without causing packet loss of the SYN signal or making the client 1 aware of the power state (suspend, returning, operating) of the server 2.

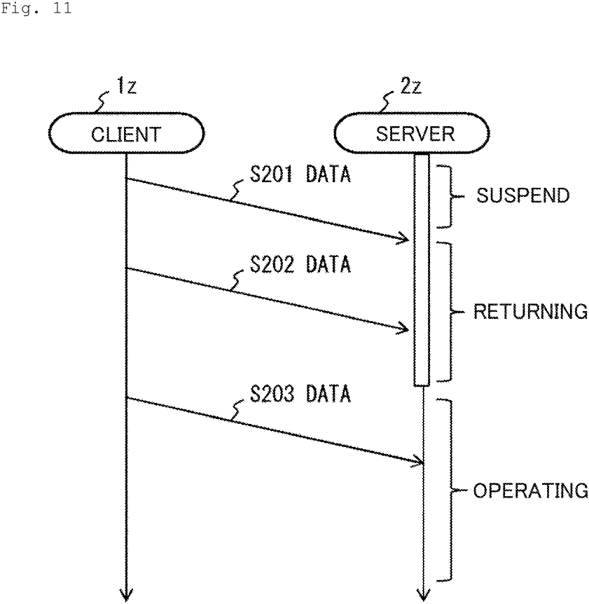

FIG. 11 is a sequence diagram showing a UDP process of a comparison example.

The client 1z sends the first DATA signal to the server 2z in the suspend state (S201), but the server 2z does not recognize it, causing packet loss. Then, the server 2z transitions from returning to operating when a magic packet is received or the power button is pressed, for example.

The client 1z sends the second DATA signal to the returning server 2z (S202), but packet loss occurs as in the first time. The client 1z further sends the third DATA signal to the server 2z (S203) . The operating server 2z starts processing with the DATA signal at S203.

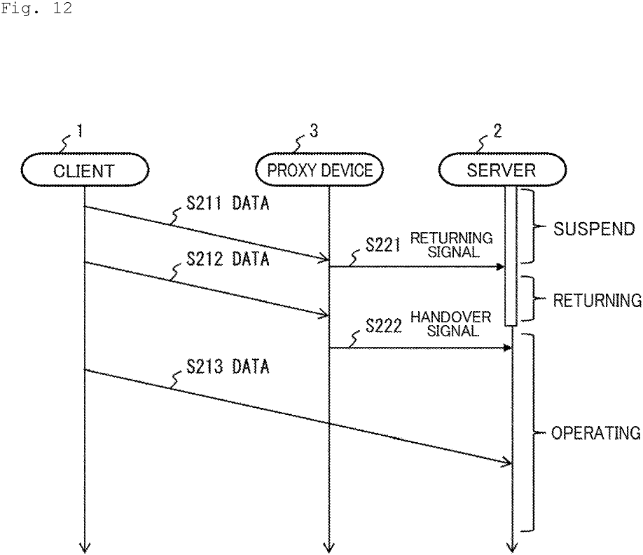

FIG. 12 is a sequence diagram showing a UDP process of the present embodiment. An example of a DATA signal of (Class C: Cannot be delegated) is described below.

The client 1 sends the first DATA signal to the proxy device 3 (S211). Since the proxy device 3 cannot process the DATA signal at S211 by itself, it stores the signal in the buffer 33 and sends a returning signal to the suspended server 2 (S221). This transitions the server 2 from returning to operating.

The client 1 sends the second DATA signal to the proxy device 3 (S212), but since the signal cannot be immediately transferred to the returning server 2, it is stored in the buffer 33.

Then, the proxy device 3 sends a handover signal to the server 2 that has transitioned to the operating state (S222) to allow the server 2 to process the DATA signals at S211 and S212 stored in the buffer 33.

Also, the client 1 sends the third DATA signal via the proxy device 3 (S213). Since the operating server 2 has already processed the DATA signals issued before operating in response to the handover signal at S222, the server 2 can immediately handle the DATA signal at S213.

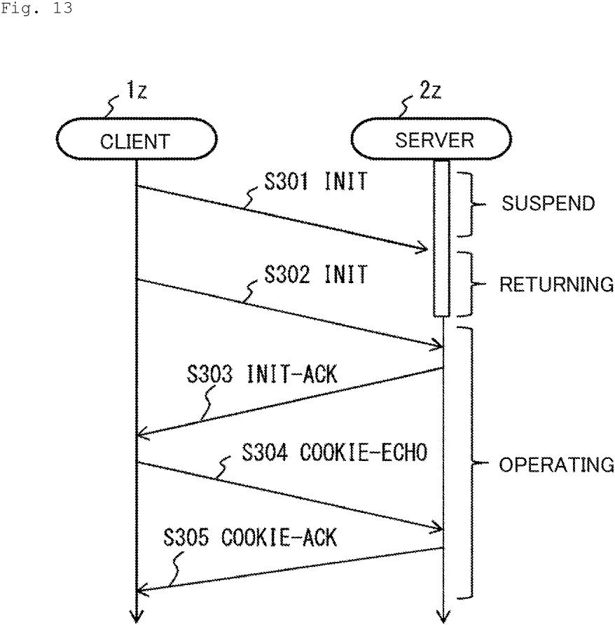

FIG. 13 is a sequence diagram showing an SCTP process of a comparison example.

The SCTP is a protocol that is an extension of the TCP shown in FIG. 9, and can resist Denial of Service (DoS) attack by a SYN flood, to which the TCP is vulnerable. To this end, the SCTP exchanges cookies (identifiers of connection requests). A 4-way handshake process with the SCTP is now described.

The client 1z sends the first INIT signal (initiation signal for starting a new connection) to the server 2z (S301). However, the INIT signal at S301 is not recognized by the server 2z because the server 2z is in the suspend state, causing packet loss. Then, the server 2z transitions from returning to operating when a magic packet is received or the power button is pressed, for example.

The client 1z sends (resends) the second INIT signal to the operating server 2z (S302). The INIT signal at S302 is correctly recognized by the operating server 2z. Then, the server 2z sends an INIT-ACK signal with a cookie to the client 1z (S303).

The client 1z sends a COOKIE-ECHO signal including the cookie notified with the INIT-ACK signal to the server 2z (S304). The server 2z sends a COOKIE-ACK signal to the client 1z (S305).

As described above, in the comparison example of FIG. 13, the packet loss of the first INIT signal causes the client 1z to be forced to wait for the second INIT signal.

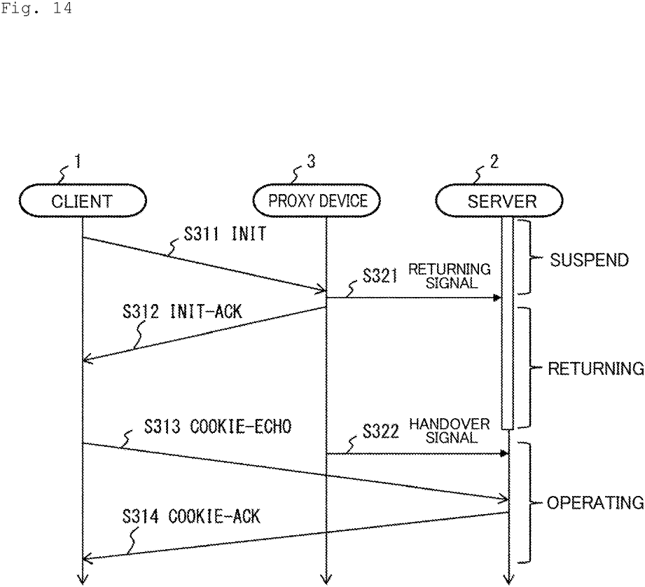

FIG. 14 is a sequence diagram showing an SCTP process of the present embodiment.

The client 1 sends an INIT signal to the proxy device 3 (S311) . The proxy device 3 returns an INIT-ACK signal to the client 1 on behalf of the server 2 in the suspend state (S312). The reply processing at S312 (Class B: Partially delegated) is immediately performed without waiting for the server 2 to return to the operating state.

The proxy device 3 stores the remaining processing belonging to the server 2 for the INIT signal at S311 in the buffer 33, and sends a returning signal to the server 2 (S321). This transitions the server 2 from returning to operating. Then, the proxy device 3 sends a handover signal to the server 2 that has transitioned to the operating state (S322) to allow the server 2 to perform the remaining processing belonging to the server 2 stored in the buffer 33.

Also, the client 1 sends a COOKIE-ECHO signal, which is a response to S312, to the server 2 via the proxy device 3 (S313). Since the operating server 2 has already processed the tasks accumulated before operating (during the suspend or returning state) in response to the handover signal, the server 2 can immediately handle the COOKIE-ECHO signal at S313.

Then, the server 2 sends a COOKIE-ACK signal, which is a response to S313, to the server 2 (S314). As a result, the 4-way handshake process is smoothly achieved without packet loss of the INIT signal.

### Advantages

According to the present invention, a power management device (proxy device 3) configured to maintain an operating state regardless of a power state of a server 2, the power state including a power saving suspend state and an operating state in which power consumption is greater than in the suspend state, includes a communication processing proxy portion 31 that
upon receiving a request signal from a client 1 for the server 2 with the power state being the suspend state, reacts by itself as a proxy, and
upon receiving the request signal from the client 1 for the server 2 with the power state being the operating state, transfers the request signal to the server 2 in the operating state.

As a result, it is possible to respond to the client 1 with a small communication processing delay while maintaining the low power consumption state of the server 2 in the suspend state.

According to the present invention, the power management device (proxy device 3) further includes a state controlling portion 32,
the communication processing proxy portion 31 stores processing of the received request signal in a buffer 33, and
the state controlling portion 32, in response to the request signal, sends the server 2 a returning signal for returning the power state of the server 2 to the operating state, and, after the power state of the server 2 transitions to the operating state, sends the server 2 a handover signal for allowing the server 2 to perform the processing of the request signal read from the buffer 33.

As a result, a task of (Class C: Cannot be delegated) can be smoothly handed over to server 2.

According to the present invention, the power management device (proxy device 3) further includes a state controlling portion 32,
the communication processing proxy portion 31 performs a part of processing for the received request signal that the communication processing proxy portion 31 is able to perform, while storing remaining processing in the buffer 33, and
the state controlling portion 32, in response to the request signal, sends the server 2 a returning signal for returning the power state of the server 2 to the operating state, and, after the power state of the server 2 transitions to the operating state, sends the server 2 a handover signal for allowing the server 2 to perform the remaining processing read from the buffer 33.

As a result, a task of (Class B: Partially delegated) can be smoothly handed over to server 2.

According to the present invention, the state controlling portion 32, when a period in which the request signal is not received from the client 1 exceeds a predetermined period, sends the server 2 a power saving signal for transitioning the power state of the server 2 to the suspend state.

As a result, power consumption can be reduced by actively placing the server 2 in the suspend state during a period of low access.

According to the present invention, the power management device (proxy device 3) and the server 2 are included, and

the one power management device (proxy device 3) and the one or more servers 2 are separate devices connected to each other by a network.

As a result, the power management device (proxy device 3) can be easily expanded using the existing server 2.

According to the present invention, the power management device (proxy device 3) and the server 2 are included, and

the power management device (proxy device 3) is provided as a component in the server 2, maintains the operating state regardless of the power state of the server 2, and transfers a request signal via an internal bus in the server 2.

As a result, the function of the power management device (proxy device 3) can be added at a low cost by utilizing the housing of the server 2 as it is.

Reference Signs List

| | |
|---|---|
| 1 | Client |
| 2 | Server |
| 3 | Proxy device (power management device) |
| 21 | Application processing portion |
| 22 | Power controlling portion |
| 31 | Communication processing proxy portion (processing proxy portion) |
| 32 | State controlling portion |
| 33 | Buffer |

1. A power management device configured to maintain an operating state regardless of a power state of a server, the power state including a power saving suspend state and an operating state in which power consumption is greater than in the suspend state, the power management device comprising:
a processing proxy portion, including one or more processors, configured to
upon receiving a request signal from a client for the server with the power state being the suspend state, react by itself as a proxy, and
upon receiving the request signal from the client for the server with the power state being the operating state, transfer the request signal to the server in the operating state.

2. The power management device according to claim 1, further comprising a state controlling portion, wherein
the processing proxy portion is configured to store processing of the received request signal in a buffer, and
the state controlling portion including one or more processors is configured to, in response to the request signal, send the server a returning signal for returning the power state of the server to the operating state, and, after the power state of the server transitions to the operating state, send the server a handover signal for allowing the server to perform the processing of the request signal read from the buffer.

3. The power management device according to claim 1, further comprising a state controlling portion, wherein
the processing proxy portion is configured to perform a part of processing for the received request signal that the processing proxy portion is able to perform, while storing remaining processing in a buffer, and
the state controlling portion including one or more processors is configured to, in response to the request signal, send the server a returning signal for returning the power state of the server to the operating state, and, after the power state of the server transitions to the operating state, send the server a handover signal for allowing the server to perform the remaining processing read from the buffer.

4. The power management device according to claim 2, wherein the state controlling portion is configured to, when a period in which the request signal is not received from the client exceeds a predetermined period, send the server a power saving signal for transitioning the power state of the server to the suspend state.

5. A power management system comprising:
the power management device according to claim 1; and
the server, wherein
the power management device and the one or more servers are separate devices connected to each other by a network.

6. A power management system comprising:
the power management device according to claim 1; and
the server, wherein
the power management device is provided as a component in the server and configured to maintain the operating state regardless of the power state of the server and transfer the request signal via an internal bus in the server.

7. A power management method comprising:
maintaining an operating state regardless of a power state of a server, the power state including a power saving suspend state and an operating state in which power consumption is greater than in the suspend state,
upon receiving a request signal from a client for the server with the power state being the suspend state, reacting by itself as a proxy, and
upon receiving the request signal from the client for the server with the power state being the operating state, transferring the request signal to the server in the operating state.

8. A non-transitory computer readable medium storing one or more instructions causing a computer to execute:
maintaining an operating state regardless of a power state of a server, the power state including a power saving suspend state and an operating state in which power consumption is greater than in the suspend state;
upon receiving a request signal from a client for the server with the power state being the suspend state, reacting by itself as a proxy; and
upon receiving the request signal from the client for the server with the power state being the operating state, transferring the request signal to the server in the operating state.

9. The power management method according to claim 7, further comprising:
storing processing of the received request signal in a buffer, and
in response to the request signal, sending the server a returning signal for returning the power state of the server to the operating state, and, after the power state of the server transitions to the operating state, sending the server a handover signal for allowing the server to perform the processing of the request signal read from the buffer.

10. The power management method according to claim 9, further comprising:
when a period in which the request signal is not received from the client exceeds a predetermined period, sending the server a power saving signal for transitioning the power state of the server to the suspend state.

11. The power management method according to claim 7, further comprising:
performing a part of processing for the received request signal, while storing remaining processing in a buffer, and
in response to the request signal, sending the server a returning signal for returning the power state of the server to the operating state, and, after the power state of the server transitions to the operating state, sending the server a handover signal for allowing the server to perform the remaining processing read from the buffer.

12. The non-transitory computer readable medium according to claim 8, wherein the one or more instructions further cause the computer to execute:
storing processing of the received request signal in a buffer, and
in response to the request signal, sending the server a returning signal for returning the power state of the server to the operating state, and, after the power state of the server transitions to the operating state, sending the server a handover signal for allowing the server to perform the processing of the request signal read from the buffer.

13. The non-transitory computer readable medium according to claim 12, wherein the one or more instructions further cause the computer to execute:
when a period in which the request signal is not received from the client exceeds a predetermined period, sending the server a power saving signal for transitioning the power state of the server to the suspend state.

14. The non-transitory computer readable medium according to claim 8, wherein the one or more instructions further cause the computer to execute:
performing a part of processing for the received request signal, while storing remaining processing in a buffer, and
in response to the request signal, sending the server a returning signal for returning the power state of the server to the operating state, and, after the power state of the server transitions to the operating state, sending the server a handover signal for allowing the server to perform the remaining processing read from the buffer.
